(19) United States
(12) Patent Application Publication
(10) Pub. No.: US 2014/0302832 A1
(43) Pub. Date: Oct. 9, 2014

(54) PHONE CONNECTION METHOD, ELECTRONIC TERMINAL AND SYSTEM

(71) Applicant: Sony Corporation, Tokyo (JP)

(72) Inventors: Bozhi FU, Beijing (CN); Nan BAO, Beijing (CN); Hongqing JIANG, Beijing (CN); Jing LI, Beijing (CN)

(73) Assignee: Sony Corporation, Tokyo (JP)

(21) Appl. No.: 14/132,330

(22) Filed: Dec. 18, 2013

(30) Foreign Application Priority Data
Apr. 4, 2013 (CN) 201310068120.0

(51) Int. Cl. H04W 4/00

(52) U.S. Cl. CPC H04W 4/008
USPC 455/417; 455/552.1

(57) ABSTRACT

The embodiments of the present invention provide a phone connection method, electronic terminal and system. The phone connection method includes: establishing a session by a first electronic terminal and a second electronic terminal; and establishing association by the first electronic terminal with a third electronic terminal by using a near-field communication device, so that the third electronic terminal establishes phone connection with the second electronic terminal. An electronic terminal includes a session establishing unit or module to establish and maintain a phone conversation or connection, and an association unit or module to associate terminals by NFC. With the embodiments of the present invention, the operational complexity in a phone connection procedure may be lowered, and better user experiences may be obtained.

### CROSS-REFERENCE TO RELATED APPLICATION AND PRIORITY CLAIM

This application claims priority from Chinese patent application No. 201310068120.0, filed Apr. 4, 2013, the entire disclosure of which hereby is incorporated by reference.

### TECHNICAL FIELD

The present invention relates to the field of mobile equipment, and in particular to a phone connection method, electronic terminal and system.

### BACKGROUND ART

Currently, electronic terminals (including a mobile phone, and a tablet computer, etc.) are widely used, and data service processing and voice service may be performed via electronic terminals. For example, conventional phone communication or network phone communication may be performed.

On the other hand, call forwarding services have appeared, in which a call may be forwarded to a phone number predetermined by a user in cases that a mobile phone is powered off, busy, and out of service zone, or the incoming call is rejected.

### SUMMARY OF THE INVENTION

However, it is found by the inventors that the operations of call forwarding in the prior art are relatively complex, as users need to predetermine a forwarded phone number, or need to manually select a forwarded target user when a call request is received (or a session has been established). Thus, the procedure for establishing phone connection is complex, and better user experiences cannot be obtained.

The embodiments of the present invention provide a phone connection method, electronic terminal and system, with an object being to lower the operational complexity in a phone connection procedure and obtain better user experiences.

According to an aspect of the embodiments of the present invention, a phone connection method is provided; the phone connection method includes:

establishing a session by a first electronic terminal and a second electronic terminal; and

establishing association by the first electronic terminal with a third electronic terminal by using a near-field communication device, so that the third electronic terminal establishes phone connection with the second electronic terminal.

According to another aspect of the embodiments of the present invention the establishing association by the first electronic terminal with a third electronic terminal by using a near-field communication device includes: receiving identification information of the third electronic terminal by the first electronic terminal by using the near-field communication device;

and the method further includes:

adding the third electronic terminal into the session according to the identification information, so that the third electronic terminal establishes phone connection with the second electronic terminal.

According to still another aspect of the embodiments of the present invention, the method further includes: exiting the session by the first electronic terminal.

According to further still another aspect of the embodiments of the present invention, a phone connection method is provided; the phone connection method including:

establishing association by a third electronic terminal with a first electronic terminal by using a near-field communication device; and

establishing phone connection by the third electronic terminal with a second electronic terminal that has established a session with the first electronic terminal.

According to further still another aspect of the embodiments of the present invention, the establishing association by a third electronic terminal with a first electronic terminal by using a near-field communication device includes:

transmitting identification information by the third electronic terminal by using the near-field communication device, so that the first electronic terminal adds the third electronic terminal into the session according to the identification information.

According to further still another aspect of the embodiments of the present invention, before the third electronic terminal establishes the phone connection with the second electronic terminal, the method further includes: acknowledging whether to add into the session by the third electronic terminal.

According to further still another aspect of the embodiments of the present invention, a phone connection method is provided; the phone connection method including:

receiving a phone request from a second electronic terminal by a first electronic terminal; and

establishing association by the first electronic terminal with a third electronic terminal by using a near-field communication device, so that the third electronic terminal establishes phone connection with the second electronic terminal.

According to further still another aspect of the embodiments of the present invention, the establishing association by the first electronic terminal with a third electronic terminal by using a near-field communication device includes: receiving identification information of the third electronic terminal by the first electronic terminal by using the near-field communication device;

and the method further includes:

forwarding the phone request of the second electronic terminal to the third electronic terminal according to the identification information, so that the third electronic terminal establishes the phone connection with the second electronic terminal.

According to further still another aspect of the embodiments of the present invention, a phone connection method is provided; the phone connection method including:

establishing association by a third electronic terminal with a first electronic terminal by using a near-field communication device; and

establishing phone connection by the third electronic terminal with a second electronic terminal transmitting a phone request to the first electronic terminal.

According to further still another aspect of the embodiments of the present invention, the establishing association by a third electronic terminal with a first electronic terminal by using a near-field communication device includes:

transmitting identification information by the third electronic terminal by using the near-field communication device, so that the first electronic terminal forwards the phone request of the second electronic terminal to the third electronic terminal according to the identification information.

According to further still another aspect of the embodiments of the present invention, before the third electronic terminal establishes the phone connection with the second electronic terminal, the method further includes:

acknowledging by the third electronic terminal that it establishes phone connection with the second electronic terminal.

According to further still another aspect of the embodiments of the present invention, an electronic terminal is provided; the electronic terminal includes a phone connection device; the phone connection device including:

a session establishing unit (also may be referred to herein as “session establishing module”—the terms “unit” and “module” being used equivalently and interchangeably herein), configured to establish a session with a second electronic terminal; and

an association establishing unit, configured to establish association with a third electronic terminal by using a near-field communication device, so that the third electronic terminal establishes phone connection with the second electronic terminal.

According to another aspect of the embodiments of the present invention, the association establishing unit receives identification information of the second electronic terminal by using the near-field communication device;

and the phone connection device further includes:

a session adding unit, configured to add the third electronic terminal into the session according to the identification information, so that the third electronic terminal establishes phone connection with the second electronic terminal.

According to still another aspect of the embodiments of the present invention, the phone connection device further includes:

a session exiting unit, configured to exit the session.

According to further still another aspect of the embodiments of the present invention, an electronic terminal is provided; the electronic terminal includes a phone connection device; the phone connection device including:

an association establishing unit, configured to establish association with a first electronic terminal by using a near-field communication device; and

a phone connecting unit, configured to establish phone connection with a second electronic terminal that has established a session with the first electronic terminal.

According to further still another aspect of the embodiments of the present invention, the association establishing unit transmits identification information by using the near-field communication device, so that the first electronic terminal adds the third electronic terminal into the session according to the identification information.

According to further still another aspect of the embodiments of the present invention, the phone connection device further includes:

an acknowledging unit, configured to acknowledge whether to add into the session.

According to further still another aspect of the embodiments of the present invention, an electronic terminal is provided; the electronic terminal includes a phone connection device; the phone connection device including:

a request receiving unit, configured to receive a phone request from a second electronic terminal; and

an association establishing unit, configured to establish association with a third electronic terminal by using a near-field communication device, so that the third electronic terminal establishes phone connection with the second electronic terminal.

According to further still another aspect of the embodiments of the present invention, the association establishing unit receives identification information of the third electronic terminal by using the near-field communication device;

and the phone connection device further includes:

a request forwarding unit, configured to forward the phone request of the second electronic terminal to the third electronic terminal according to the identification information, so that the third electronic terminal establishes the phone connection with the second electronic terminal.

According to further still another aspect of the embodiments of the present invention, an electronic terminal is provided; the electronic terminal includes a phone connection device; the phone connection device including:

an association establishing unit, configured to establish association with a first electronic terminal by using a near-field communication device; and

a phone connecting unit, configured to establish phone connection with a second electronic terminal transmitting a phone request to the first electronic terminal.

According to further still another aspect of the embodiments of the present invention, the association establishing unit transmits identification information by using the near-field communication device, so that the first electronic terminal forwards the phone request of the second electronic terminal to the third electronic terminal according to the identification information.

According to further still another aspect of the embodiments of the present invention, the phone connection device further includes:

an acknowledging unit, configured to acknowledge that it establishes phone connection with the second electronic terminal.

According to further still another aspect of the embodiments of the present invention, a phone connection system is provided; the phone connection system including:

a first electronic terminal, configured to establish a session with a second electronic terminal, and to establish association with a third electronic terminal by using a near-field communication device, so that the third electronic terminal establishes phone connection with the second electronic terminal;

a second electronic terminal, configured to establish a session with the first electronic terminal, and to establish phone connection with the third electronic terminal via the first electronic terminal; and

a third electronic terminal, configured to establish association with the first electronic terminal by using the near-field communication device, and to establish phone connection with the second electronic terminal via the first electronic terminal.

According to further still another aspect of the embodiments of the present invention, a phone connection system is provided; the phone connection system including:

a first electronic terminal, configured to receive a phone request of a second electronic terminal, and to establish association with a third electronic terminal by using a near-field communication device, so that the third electronic terminal establishes phone connection with the second electronic terminal;

a second electronic terminal, configured to transmit a phone request to the first electronic terminal, and to establish phone connection with the third electronic terminal via the first electronic terminal; and

a third electronic terminal, configured to establish association with the first electronic terminal by using a near-field communication device, and to establish phone connection with the second electronic terminal via the first electronic terminal.

Advantages of the embodiments of the present invention include: other electronic terminal is added into a session, or a phone request is forwarded to other electronic terminal, by using a near-field communication device, thereby lowering the operational complexity in a phone connection procedure and obtaining better user experiences.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present invention, which constitute a part of the specification and illustrate the preferred embodiments of the present invention, and are used for setting forth the principles of the present invention together with the description. The same element is represented with the same reference number throughout the drawings.

In the drawings:

FIG. 1 is a flowchart of the phone connection method of Embodiment 1 of the present invention;

FIG. 2 is another flowchart of the phone connection method of Embodiment 1 of the present invention;

FIG. 3 is a schematic diagram of the phone connection method of Embodiment 1 of the present invention;

FIG. 4 is a flowchart of the phone connection method of Embodiment 2 of the present invention;

FIG. 5 is a schematic diagram of the phone connection method of Embodiment 3 of the present invention;

FIG. 6 is another flowchart of the phone connection method of Embodiment 3 of the present invention;

FIG. 7 is a flowchart of the phone connection method of Embodiment 4 of the present invention;

FIG. 8 is a schematic diagram of the electronic terminal of Embodiment 5 of the present invention;

FIG. 9 is a schematic diagram of the electronic terminal of Embodiment 6 of the present invention;

FIG. 10 is a schematic diagram of the electronic terminal of Embodiment 7 of the present invention;

FIG. 11 is a schematic diagram of the electronic terminal of Embodiment 8 of the present invention;

FIG. 12 is a schematic diagram of the phone connection system of Embodiment 9 of the present invention; and

FIG. 13 is a block diagram of the systematic construction of the electronic terminal of Embodiment 9 of the present invention.

### DETAILED DESCRIPTION OF THE INVENTION

The interchangeable terms “electronic apparatus” and “electronic device” include portable radio communication apparatus. The term “portable radio communication apparatus”, which hereinafter may be referred to as a “mobile terminal”, “portable electronic device”, or “portable communication device”, includes all apparatuses such as mobile telephones, pagers, communicators, electronic organizers, personal digital assistants (PDAs), smartphones, portable communication devices or the like.

In the present application, embodiments of the invention are described primarily in the context of a portable electronic device in the form of a mobile telephone (also referred to as “mobile phone”). However, it shall be appreciated that the invention is not limited to the context of a mobile telephone and may relate to any type of appropriate electronic apparatus, and examples of such electronic apparatus include a media player, a game device, a PDA and computer, a digital video camera, and a tablet computer, etc.

In the present application, a phone session or phone request may be mobile phone communication in a conventional sense, in which phone connection is performed via a telecommunications network; and may also be network phone in which phone connection is performed via the Internet, such as VoIP (voice over Internet protocol), etc. However, the present invention is not limited thereto.

### Embodiment 1

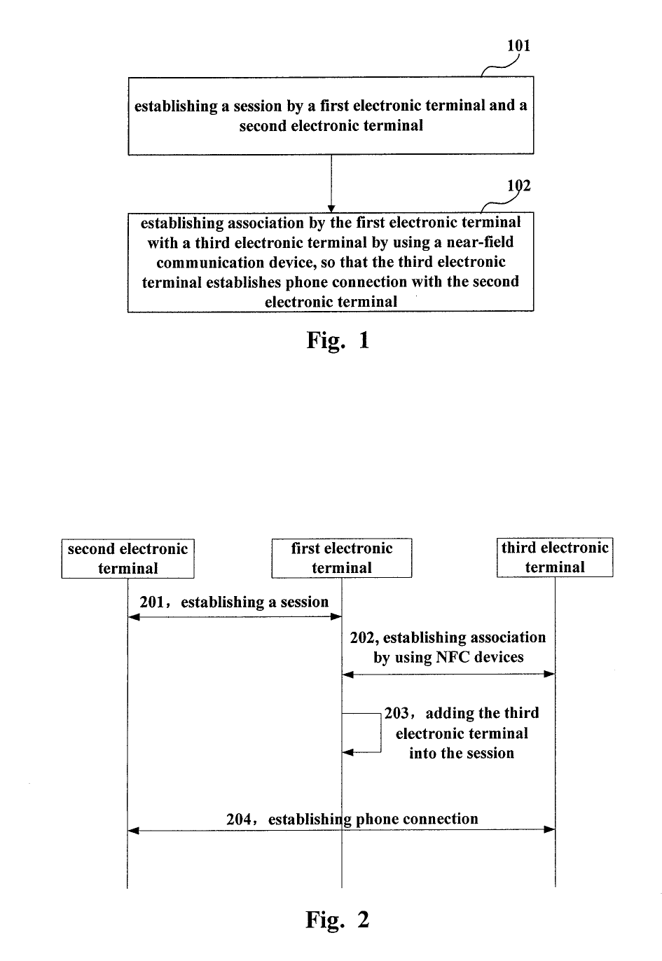

An embodiment of the present invention provides a phone connection method, applicable to a first electronic terminal side. FIG. 1 is a flowchart of the phone connection method of an embodiment of the present invention. As shown in FIG. 1, the phone connection method includes:

step 101: establishing a session by a first electronic terminal and a second electronic terminal; and

step 102: establishing association by the first electronic terminal with a third electronic terminal by using a near-field communication device, so that the third electronic terminal establishes phone connection with the second electronic terminal.

In this embodiment, the first electronic terminal may establish a session with the second electronic terminal first; the session in the present invention may refer to a state of keeping phone conversation or a state of phone connection, etc. Then a third electronic terminal may be added into the session as needed by the services, etc. Association may be established between the first electronic terminal and the third electronic terminal by near-field communication (NFC) touch using an NFC device of the first electronic terminal and an NFC device of the third electronic terminal.

The NFC technology is a near-field communication technology, which is designed to transmit data in a range of 10 cm (usually effective in a range of 1-2 cm in practical applications), in order to avoid accidents or unauthorized activation of the links. The prior art may be referred to for details of an NFC device and the protocols, which shall not be described herein any further.

For example, when a user A (using an electronic terminal 1) is in discussion over phone with user B (using an electronic terminal 2) (that is, a conference call is established), a user C (using an electronic terminal 3) near the user A is needed to communicate with the user B. The user A may cause the electronic terminal 1 to be in close contact with the electronic terminal 3, and associate the electronic terminal 1 with the electronic terminal 3 by using NFC devices, so that the electronic terminal 1 may be taken as a host device of the conference call, and the electronic terminal 3 is added into the conference call, thereby making the electronic terminal 2 to establish phone connection with the electronic terminal 3, and the user B may communicate with the user C over the phone.

Hence, the user A and the user C need only to be in contact with each other at a certain distance, without needing to be preset or operated manually, thereby lowering the operational complexity and obtaining better user experiences.

In particular implementation, the establishing association by the first electronic terminal with a third electronic terminal by using an NFC device in step 102 includes: receiving identification information of the third electronic terminal by the first electronic terminal by using the NFC device.

The method may further include: adding the third electronic terminal into the session according to the identification information, so that the third electronic terminal establishes phone connection with the second electronic terminal.

In this embodiment, the first electronic terminal may exchange information with the third electronic terminal via the NFC device. The identification information may be the number of the third electronic terminal, etc. The first electronic terminal may add the third electronic terminal into the session according to the identification information. The prior art or existing protocols may be referred to for how to add into the session.

It should be noted that the above description is given taking only that the first electronic terminal is taken as a host device. However, the present disclosure, also referred to as invention, is not limited thereto. For example, the first electronic terminal may also transmit the obtained identification information of the third electronic terminal to the second electronic terminal, and the second electronic terminal is taken as a host device to add the third electronic terminal into the session. Particular implementation may be determined as actually required.

Furthermore, the electronic terminals in the present invention may also be mobile terminals. However, the present disclosure (invention) is not limited thereto. For example, the electronic terminals may be fixed phones; or may be partly mobile terminals, and partly fixed phones. Particular devices may be determined as actually required.

For example, when the users A and B are in a phone conference with the user C via a fixed phone X, and the user B has to exit in emergency, but needs to be on line, the user B may make a mobile terminal Y of its own to be in NFC contact with the fixed phone X and add into the phone conference, and then the user B may exit the conference room, but still keep on line via the mobile terminal Y.

In this embodiment, after the third electronic terminal is added into the session, the first electronic terminal may proceed with the phone discussion with the second and third electronic terminals. And the first electronic terminal may also exit the session, and the second and third electronic terminals may perform direct phone connection. Particular times for exiting the session may be determined as actually required.

FIG. 2 is another flowchart of the phone connection method of the embodiment of the present invention. As shown in FIG. 2, the phone connection method includes:

step 201: establishing a session by a first electronic terminal with a second electronic terminal;

step 202: establishing association by the first electronic terminal with a third electronic terminal by using an NFC device, and receiving identification information of the third electronic terminal;

step 203: adding the third electronic terminal into the session by the first electronic terminal according to the identification information; and

step 204: establishing phone connection by the third electronic terminal with the second electronic terminal.

In this embodiment, the function of the NFC device may be carried out by an NFC antenna and software modules; however, the present invention is not limited thereto.

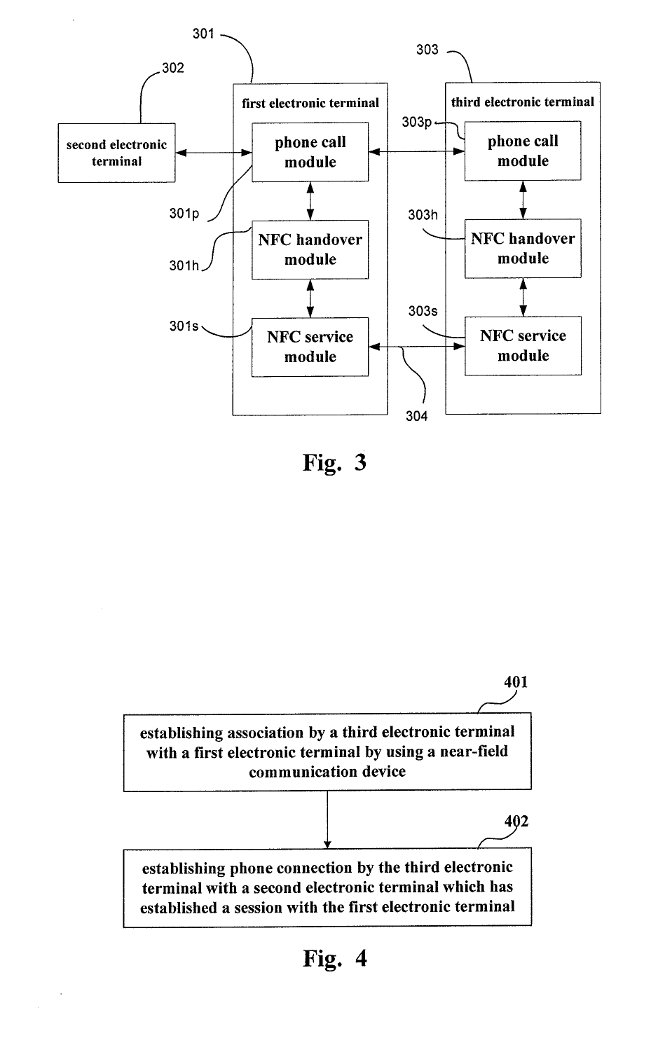

FIG. 3 is a schematic diagram of the phone connection method of the embodiment of the present invention. As shown in FIG. 3, there are first 301, second 302 and third 303 electronic terminals. The first electronic terminal 301 and the third electronic terminal 303 may have respectively an NFC antenna (not shown) and a phone call module, an NFC handover module, and an NFC service module. As shown in FIG. 3, the first electronic terminal 301 has established phone connection with the second electronic terminal 302, and then the NFC antennas of the first electronic terminal and the third electronic terminal are made close to each other.

As shown in FIG. 3, the NFC service module 301s of the first electronic terminal 301 receives an underlying message, acknowledges that an NFC data link layer 304 has been connected, and transmits the message to the NFC handover module 301h, and the NFC handover module 301h transmits a data request to the phone call module 301p; the phone call module 301p may transmit both the number of the first electronic terminal 301 and the number of the second electronic terminal 302 to the NFC handover module 301h, the NFC handover module 301h packages the data and then transmits to the NFC service module 301s, and the NFC service module 301s transmits the packaged data to the third electronic terminal 303.

As shown in FIG. 3, the packaged data are transmitted to the NFC handover module 303h by the NFC service module 303s of the third electronic terminal, and the NFC handover module 303h transmits the data to the phone call module 303p. A user of the third electronic terminal may perform acknowledgement, then transmits the number of the third electronic terminal and an acknowledgement message to the NFC handover module 303h, and transmits the data packet to the NFC service module 303s, and the NFC service module 303s transmits the data packet to the first electronic terminal 301.

As shown in FIG. 3, the first electronic terminal 301 may transmit the data to the NFC handover module 301h via the NFC service module 301s and analyzes the data packet. If the acknowledgement message is received, the number of the third electronic terminal 303 may be transmitted to the phone call module 301p, and the phone call module 301p dials the number of the third electronic terminal and establishes a phone conference.

It should be noted that how to exchange information via NFC is illustrated above only. However, the present invention is not limited thereto. For example, the above order of execution may be changed, or the identification information is only transmitted by the third electronic terminal, while the first electronic terminal does not transmit the identification information. Particular implementation may be determined as actually required.

It can be seen from the above embodiment that an electronic terminal may establish association with other electronic terminals by using an NFC device, so as to add the other electronic terminals into the session, thereby lowering the operational complexity and obtaining better user experiences.

### Embodiment 2

An embodiment of the present invention provides a phone connection method, applicable to a third electronic terminal side. The parts identical to those in Embodiment 1 shall not be described any further.

FIG. 4 is a flowchart of the phone connection method of the embodiment of the present invention. As shown in FIG. 4, the phone connection method includes:

step 401: establishing association by a third electronic terminal with a first electronic terminal by using a near-field communication device; and

step 402: establishing phone connection by the third electronic terminal with a second electronic terminal which has established a session with the first electronic terminal.

In particular implementation, the establishing association by a third electronic terminal with a first electronic terminal by using an NFC device in step 401 may include: transmitting identification information by the third electronic terminal by using the NFC device, so that the first electronic terminal adds the third electronic terminal into the session according to the identification information.

In this embodiment, the third electronic terminal may exchange information with the first electronic terminal via the NFC device. For example, the third electronic terminal may transmit a number to the first electronic terminal, and the first electronic terminal may transmit such information as the number of the second electronic terminal, etc., to the third electronic terminal. However, the present invention is not limited thereto, and particular exchanged information may be determined as actually required.

In this embodiment, before the third electronic terminal establishes the phone connection with the second electronic terminal, the method may further include: acknowledging whether to add into the session by the third electronic terminal.

In particular implementation, the third electronic terminal may pop up acknowledgement information for acknowledgement by the user after establishing the association with the first electronic terminal, which may be “whether to add into the phone session”, for example; or more information may be displayed according to the received information of the second electronic terminal, which may be “whether to make conversation with the second electronic terminal”, for example. However, the present invention is not limited thereto, and particular acknowledgement information may be determined as actually required.

It can be seen from the above embodiment that an electronic terminal may establish association with other electronic terminals by using an NFC device, and is added into the session via the other electronic terminals, thereby lowering the operational complexity in the phone connection process and obtaining better user experiences.

### Embodiment 3

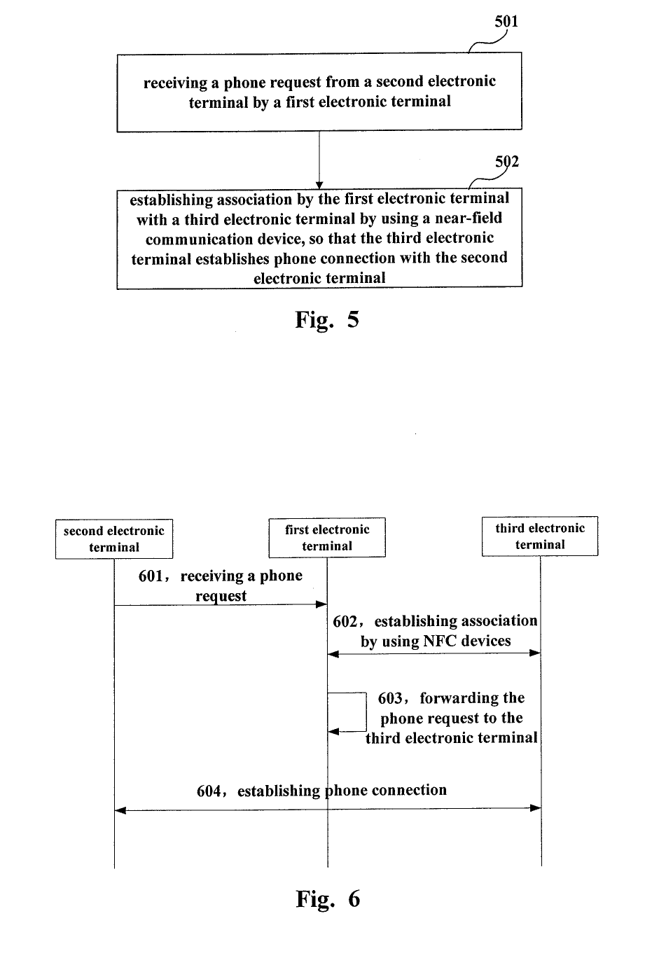

An embodiment of the present invention provides a phone connection method, applicable to a first electronic terminal side. FIG. 5 is a schematic diagram of the phone connection method of the embodiment of the present invention. As shown in FIG. 5, the phone connection method includes:

step 501: receiving a phone request from a second electronic terminal by a first electronic terminal; and

step 502: establishing association by the first electronic terminal with a third electronic terminal by using a near-field communication device, so that the third electronic terminal establishes phone connection with the second electronic terminal.

In this embodiment, when the first electronic terminal receives the phone request of the second electronic terminal, it may forward the phone request to the third electronic terminal if it is inconvenient to hear. The association between the first electronic terminal and the third electronic terminal may be established by using an NFC device owned by, e.g., part of, the first electronic terminal and an NFC device owned by, e.g., part of, the third electronic terminal.

For example, when a user A (using an electronic terminal 1) cannot hear due to being busy and hopes a secretary C (using an electronic terminal 3) to handle a phone request in receiving the phone request of a user B (using an electronic terminal 2), the user A may cause the electronic terminal 1 to be in close contact with the electronic terminal 3, and associate the electronic terminal 1 with the electronic terminal 3 via NFC devices, so that the electronic terminal 1 may forward the phone request to the electronic terminal 3. In this way, the electronic terminal 2 may establish phone connection with the electronic terminal 3, and the user B may communicate with the user C over the phone.

Hence, the user A and the user C need only to be in contact with each other at a certain distance, without needing to be preset or operated manually, thereby lowering the operational complexity and obtaining better user experiences.

In particular implementation, the establishing association by the first electronic terminal with a third electronic terminal by using an NFC device in step 501 may include: receiving identification information of the third electronic terminal by the first electronic terminal by using the NFC device.

The method may further include: forwarding the phone request of the second electronic terminal to the third electronic terminal according to the identification information, so that the third electronic terminal establishes the phone connection with the second electronic terminal.

In particular implementation, the first electronic terminal forwards the phone request to the third electronic terminal according to the identification information, which may be automatically carried out at the background by using software modules, etc. For example, the first electronic terminal and the second electronic terminal may be automatically triggered to be connected by NFC touch between the first electronic terminal and the third electronic terminal, so as to establish a conference call; then the first electronic terminal may add the third electronic terminal into the conference call according to the obtained identification information; and finally, the first electronic terminal exits the conference call, and the third electronic terminal and the second electronic terminal establish phone connection.

Therefore, the first electronic terminal may automatically forward the phone request of the second electronic terminal to the third electronic terminal, without needing the participation of a user of the first electronic terminal. In this way, the phone connection may be performed conveniently by using an NFC device, and a user of the first electronic terminal is not needed to participate in making the connection, thereby meeting demands in multiple scenarios (such as that the user is busy, or is inconvenient to hear, etc.). It should be noted that only how to perform forwarding of a phone request is illustrated above. However, the present invention is not limited thereto, and other manners may also be used.

FIG. 6 is another flowchart of the phone connection method of the embodiment of the present invention. As shown in FIG. 6, the phone connection method includes:

step 601: receiving a phone request of a second electronic terminal by a first electronic terminal;

step 602: establishing association by the first electronic terminal with a third electronic terminal by using an NFC device, and receiving identification information of the third electronic terminal;

step 603: forwarding the phone request by the first electronic terminal to the third electronic terminal according to the identification information; and

step 604: establishing phone connection by the third electronic terminal with the second electronic terminal.

It can be seen from the above embodiment that an electronic terminal may establish association with other electronic terminals by using an NFC device, so as to forward the phone request to the other electronic terminals, thereby lowering the operational complexity in the phone connection process and obtaining better user experiences.

### Embodiment 4

An embodiment of the present invention provides a phone connection method, applicable to a third electronic terminal side. The parts identical to those in Embodiment 3 shall not be described any further.

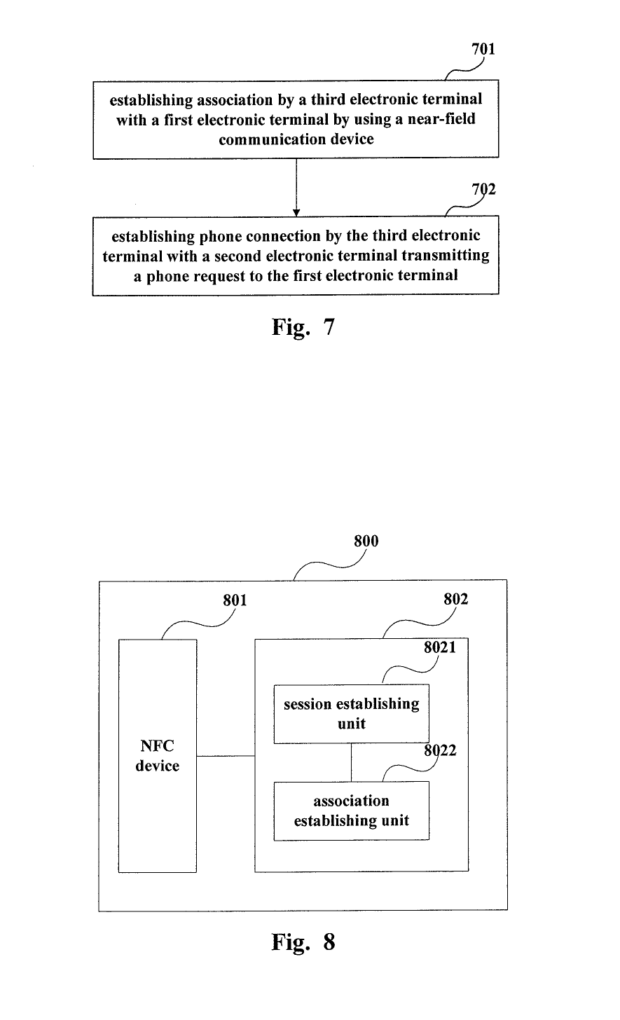

FIG. 7 is a flowchart of the phone connection method of the embodiment of the present invention. As shown in FIG. 7, the phone connection method includes:

step 701: establishing association by a third electronic terminal with a first electronic terminal by using a near-field communication device; and

step 702: establishing phone connection by the third electronic terminal with a second electronic terminal transmitting a phone request to the first electronic terminal.

In particular implementation, the establishing association by a third electronic terminal with a first electronic terminal by using a near-field communication device in step 701 may include: transmitting identification information by the third electronic terminal by using the near-field communication device, so that the first electronic terminal forwards the phone request of the second electronic terminal to the third electronic terminal according to the identification information.

In this embodiment, the third electronic terminal may exchange information with the first electronic terminal via the NFC device. For example, the third electronic terminal may transmit a number to the first electronic terminal, and the first electronic terminal may transmit such information as the number of the second electronic terminal, etc., to the third electronic terminal. However, the present invention is not limited thereto, and particular exchanged information may be determined as actually required.

In this embodiment, before the third electronic terminal establishes the phone connection with the second electronic terminal, the method may further include: acknowledging by the third electronic terminal whether to establish phone connection with the second electronic terminal.

In particular implementation, the third electronic terminal may pop up acknowledgement information for acknowledgement by the user after establishing the association with the first electronic terminal, which may be “whether to hear the call forwarded by the user A”, for example; or more information may be displayed according to the received information of the second electronic terminal, which may be “whether to hear the call from the user B forwarded by the user A”, for example. However, the present invention is not limited thereto, and particular acknowledgement information may be determined as actually required.

It can be seen from the above embodiment that an electronic terminal may establish association with other electronic terminals by using an NFC device, so as to receive phone requests forwarded by the other electronic terminals, thereby lowering the operational complexity in the phone connection process and obtaining better user experiences.

### Embodiment 5

An embodiment of the present invention provides an electronic terminal, including a phone connection device. This embodiment corresponds to the phone connection method as described in Embodiment 1, and the identical parts shall not be described any further.

FIG. 8 is a schematic diagram of an electronic terminal of this embodiment of the present invention. As shown in FIG. 8, the electronic terminal 800 includes an NFC device 801 and a phone connection device 802. The prior art may referred to for other parts of the electronic terminal.

As shown in FIG. 8, the phone connection device 802 includes: a session establishing unit 8021 and an association establishing unit 8022.

The session establishing unit 8021 is configured to establish a session with a second electronic terminal, and the association establishing unit 8022 is configured to establish association with a third electronic terminal by using the NFC device, so that the third electronic terminal establishes phone connection with the second electronic terminal.

In an embodiment, the association establishing unit 8022 receives identification information of the second electronic terminal by using the NFC device.

The phone connection device 802 may further include: a session adding unit configured to add the third electronic terminal into the session according to the identification information, so that the third electronic terminal establishes phone connection with the second electronic terminal.

In another embodiment, the association establishing unit 8022 may transmit identification information of the electronic terminal (i.e. the first electronic terminal) and the second electronic terminal via the NFC device. On the other hand, the third electronic terminal may be added into the session by other devices (such as the second electronic terminal), so that the third electronic terminal establishes phone connection with the second electronic terminal.

In another embodiment, the phone connection device 802 may further include: a session exiting unit configured to exit the session.

It can be seen from the above embodiment that an electronic terminal may establish association with other electronic terminals by using an NFC device, so as to add the other electronic terminals into the session, thereby lowering the operational complexity in the phone connection process and obtaining better user experiences.

### Embodiment 6

An embodiment of the present invention provides an electronic terminal, including a phone connection device. This embodiment corresponds to the phone connection method as described in Embodiment 2, and the identical parts shall not be described any further.

FIG. 9 is a schematic diagram of an electronic terminal of this embodiment of the present invention. As shown in FIG. 9, the electronic terminal 900 includes an NFC device 901 and a phone connection device 902. The prior art may referred to for other parts of the electronic terminal.

As shown in FIG. 9, the phone connection device 902 includes: an association establishing unit 9021 and a phone connecting unit 9022.

The association establishing unit 9021 is configured to establish association with a first electronic terminal by using the NFC device 901; and the phone connecting unit 9022 is configured to establish phone connection with a second electronic terminal that has established a session with the first electronic terminal.

In particular implementation, the association establishing unit 9021 transmits identification information by using the NFC device 901, so that the first electronic terminal adds the third electronic terminal into the session according to the identification information.

In this embodiment, the phone connection device 902 may further include: an acknowledging unit configured to acknowledge whether to be added into the session.

It can be seen from the above embodiment that an electronic terminal may establish association with other electronic terminals by using an NFC device, and is added into the session by the other electronic terminals, thereby lowering the operational complexity in the phone connection process and obtaining better user experiences.

### Embodiment 7

An embodiment of the present invention provides an electronic terminal, including a phone connection device. This embodiment corresponds to the phone connection method as described in Embodiment 3, and the identical parts shall not be described any further.

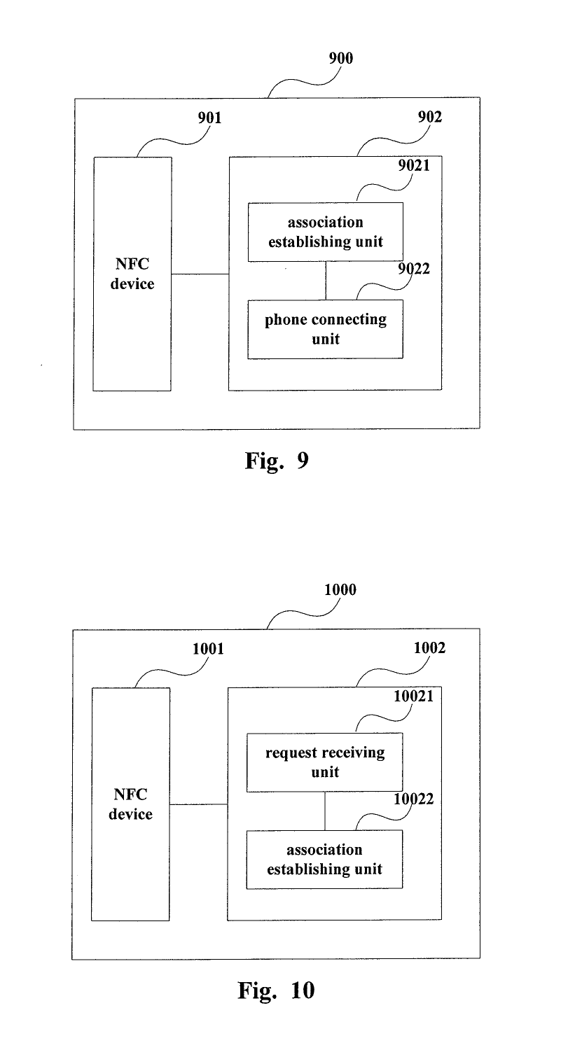

FIG. 10 is a schematic diagram of an electronic terminal of this embodiment of the present invention. As shown in FIG. 10, the electronic terminal 1000 includes an NFC device 1001 and a phone connection device 1002. The prior art may referred to for other parts of the electronic terminal.

As shown in FIG. 10, the phone connection device 1002 includes: a request receiving unit 10021 and an association establishing unit 10022.

The request receiving unit 10021 is configured to receive a phone request from a second electronic terminal, and the association establishing unit 10022 is configured to establish association with a third electronic terminal by using the NFC device 1001, so that the third electronic terminal establishes phone connection with the second electronic terminal.

In particular implementation, the association establishing unit 10021 receives identification information of the third electronic terminal by using the NFC device 1001.

The phone connection device 1002 may further include: a request forwarding unit configured to forward the phone request of the second electronic terminal to the third electronic terminal according to the identification information, so that the third electronic terminal establishes the phone connection with the second electronic terminal.

It can be seen from the above embodiment that an electronic terminal may establish association with other electronic terminals by using an NFC device, so as to forward the phone request to the other electronic terminals, thereby lowering the operational complexity in the phone connection process and obtaining better user experiences.

### Embodiment 8

An embodiment of the present invention provides an electronic terminal, including a phone connection device. This embodiment corresponds to the phone connection method as described in Embodiment 4, and the identical parts shall not be described any further.

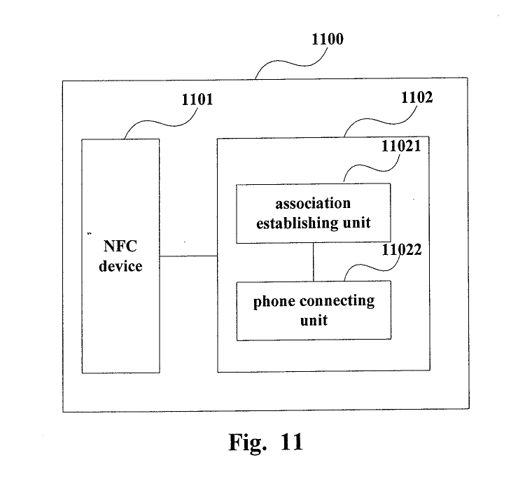

FIG. 11 is a schematic diagram of an electronic terminal of this embodiment of the present invention. As shown in FIG. 11, the electronic terminal 1100 includes an NFC device 1101 and a phone connection device 1102. The prior art may referred to for other parts of the electronic terminal.

As shown in FIG. 11, the phone connection device 1102 includes: an association establishing unit 11021 and a phone connecting unit 11022.

The association establishing unit 11021 is configured to establish association with a first electronic terminal by using the NFC device 1101, and the phone connecting unit 11022 is configured to establish phone connection with a second electronic terminal transmitting a phone request to the first electronic terminal.

In particular implementation, the association establishing unit 11021 may transmit identification information by using the NFC device 1001, so that the first electronic terminal forwards the phone request of the second electronic terminal to the third electronic terminal according to the identification information.

In this embodiment, the phone connection device 1102 may further include: an acknowledging unit configured to acknowledge whether to establish phone connection with the second electronic terminal.

It can be seen from the above embodiment that an electronic terminal may establish association with other electronic terminals by using an NFC device, so as to receive phone request forwarded by the other electronic terminals, thereby lowering the operational complexity in the phone connection process and obtaining better user experiences.

### Embodiment 9

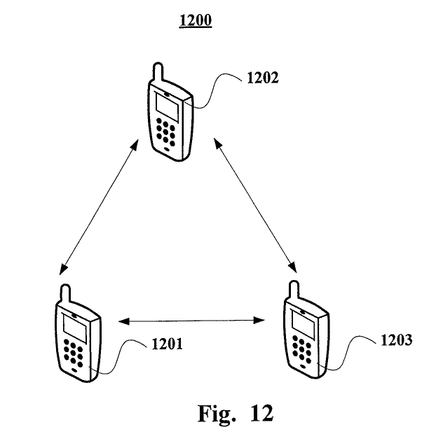

An embodiment of the present invention provides a phone connection system. FIG. 12 is a schematic diagram of a phone connection system of an embodiment of the present invention, in which only some devices are shown for the sake of simplicity. As shown in FIG. 12, the phone connection system 1200 may include: a first electronic terminal 1201, a second electronic terminal 1202 and a third electronic terminal 1203.

In an embodiment, the first electronic terminal 1201 is configured to establish a session with the second electronic terminal 1202, and to establish association with the third electronic terminal 1203 by using an NFC device, so that the third electronic terminal 1203 establishes phone connection with the second electronic terminal 1202;

the second electronic terminal 1202 is configured to establish a session with the first electronic 1201, and to establish phone connection with the third terminal electronic terminal 1203 via the first electronic terminal 1201; and

the third electronic terminal 1203 is configured to establish association with the first electronic terminal 1201 by using the NFC device, and to establish phone connection with the second electronic terminal 1202 via the first electronic terminal 1201.

In another embodiment, the first electronic terminal 1201 receives a phone request of the second electronic terminal 1202, and to establish association with the third electronic terminal 1203 by using an NFC device, so that the third electronic terminal 1203 establishes phone connection with the second electronic terminal 1202;

the second electronic terminal 1202 transmits a phone request to the first electronic terminal 1201, and to establish phone connection with the third electronic terminal 1203 via the first electronic terminal 1201; and

the third electronic terminal 1203 establishes association with the first electronic terminal 1201 by using an NFC device, and to establish phone connection with the second electronic terminal 1202 via the first electronic terminal 1201.

In this embodiment, the first electronic terminal 1201 and the third electronic terminal 1203 have NFC devices. The first electronic terminal 1201 has the phone connection device as described in Embodiment 5 or 7, and the third electronic terminal 1203 has the phone connection device as described in Embodiment 6 or 8.

It should be noted that this embodiment is described taking only three electronic terminals as an example. However, the present invention is not limited thereto. For example, more than three electronic terminals may also be used for phone connection, and particular manners of implementation may be determined as actually required.

An embodiment of the present invention further provides an electronic terminal, including the phone connection device as described in embodiments 5-8.

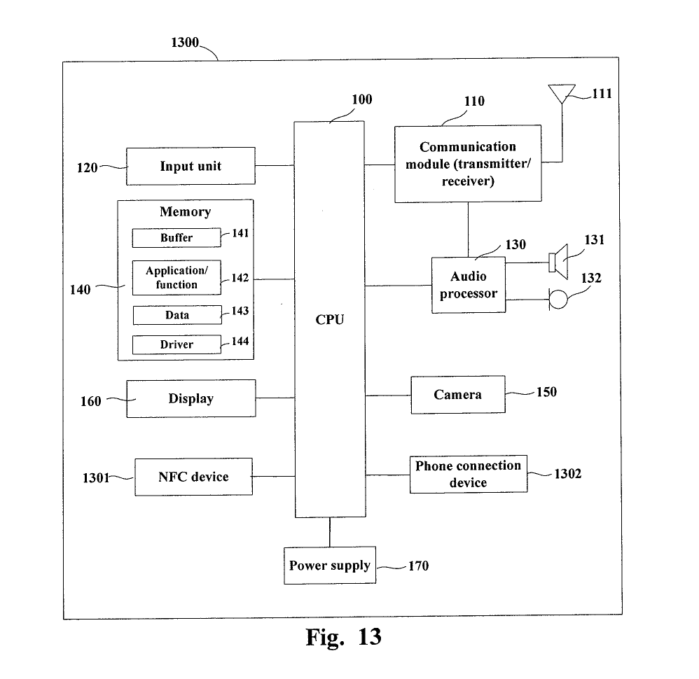

FIG. 13 is a block diagram of the system construction of an electronic terminal 1300 of embodiments of the present invention, including an NFC device 1301 and a phone connection device 1302. The phone connection device 1302 may be the phone connection device 802, the phone connection device 902, the phone connection device 1002, or the phone connection device 1102, as describe above.

As shown in FIG. 13, the NFC device 1301 and phone connection device 1302 may be connected to a CPU 100. It should be noted that this diagram is illustrative only, and structures of other types may also be used to supplement or replace this structure, so as to implement telecommunications functions or other functions.

As shown in FIG. 13, the mobile terminal 1300 may further include the CPU 100, a communication module 110, an input unit 120, an audio processing unit 130, a memory 140, a camera 150, a display 160, and a power supply 170.

The CPU 100 (also referred to as a controller or an operational control, which may include a microprocessor or other processing devices and/or logic devices) receives input and controls each part and operation of the mobile terminal 1300. The input unit 120 provides input to the CPU 100. The input unit 120 may be for example a key or touch input device. The camera 150 is used to take image data and provide the taken image data to the CPU 100 for use in a conventional manner, for example, for storage, and transmission, etc.

The power supply 170 is used to supply power to the mobile terminal 1300. And the display 160 is used to display the objects of display, such as images, and characters, etc. The display may be for example an LCD display, but it is not limited thereto.

The memory 140 is coupled to the CPU 100. The memory 140 may be a solid state memory, such as a read-only memory (ROM), a random access memory (RAM), and a SIM card, etc., and may also be such a memory that stores information when the power is interrupted, may be optionally erased and provided with more data. Examples of such a memory are sometimes referred to as an EPROM, etc. The memory 140 may also be certain other types of devices. The memory 140 includes a buffer memory 141 (sometimes referred to as a buffer). The memory 140 may include an application/function storing portion 142 used to store application programs and function programs, or to execute the flow of the operation of the mobile terminal 1300 via the CPU 100.

The memory 140 may further include a data storing portion 143 used to store data, such as a contact person, digital data, pictures, voices and/or any other data used by an electronic apparatus. A driver storing portion 144 of the memory 140 may include various types of drivers of the electronic apparatus for the communication function and/or for executing other functions (such as application of message transmission, and application of directory, etc.).

The communication module 110 is a transmitter/receiver 110 transmitting and receiving signals via an antenna 111. The communication module (transmitter/receiver) 110 is coupled to the CPU 100 to provide input signals and receive output signals, this being similar to the case in a conventional mobile phone.

A plurality of communication modules 110 may be provided in the same electronic apparatus for various communication technologies, such a cellular network module, a Bluetooth module, and/or a wireless local network module, etc. The communication module (transmitter/receiver) 110 is also coupled to a loudspeaker 131 and a microphone 132 via the audio processing unit 130, for providing audio output via the loudspeaker 131 and receiving the audio input from the microphone 132, thereby achieving common telecommunications function. The audio processing unit 130 may include any suitable buffers, decoders, and amplifiers, etc. The audio processing unit 130 is further coupled to the CPU 100, thereby enabling the recording of voices in this device via the microphone 132 and playing the voices stored in this device via the loudspeaker 131.

An embodiment of the present invention further provides a computer-readable program, wherein when the program is executed in an electronic terminal, the program enables the computer to carry out the phone connection method as described in any one of embodiments 1-4 in the electronic terminal.

An embodiment of the present invention further provides a storage medium in which a computer-readable program is stored, wherein the computer-readable program enables the computer to carry out the phone connection method as described in any one of embodiments 1-4 in an electronic terminal.

The preferred embodiments of the present invention are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of including one or more modules, segments or parts for realizing the codes of executable instructions of the steps in specific logic functions or processes, and that the scope of the preferred embodiments of the present invention include other implementations, wherein the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present invention. It should be understood that those skilled in the art may prepare appropriate computer codes to carry out each of the steps and processes as described above and shown in the drawings. It should be also understood that all the terminals, computers, servers, and networks may be any type, and the computer codes may be prepared according to the disclosure to carry out the present invention by using the apparatus.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. A phone connection method, comprising:
establishing a session by a first electronic terminal and a second electronic terminal; and
establishing association by the first electronic terminal with a third electronic terminal by using a near-field communication device, so that the third electronic terminal establishes phone connection with the second electronic terminal.

2. The method according to claim 1, wherein the establishing association by the first electronic terminal with a third electronic terminal by using a near-field communication device comprises: receiving identification information of the third electronic terminal by the first electronic terminal by using the near-field communication device;
and the method further comprises:
adding the third electronic terminal into the session according to the identification information, so that the third electronic terminal establishes phone connection with the second electronic terminal.

3. The method according to claim 2, wherein the method further comprises: exiting the session by the first electronic terminal.

4. A phone connection method, comprising:
establishing association by a third electronic terminal with a first electronic terminal by using a near-field communication device; and
establishing phone connection by the third electronic terminal with a second electronic terminal that has established a session with the first electronic terminal.

5. The method according to claim 4, wherein the establishing association by a third electronic terminal with a first electronic terminal by using a near-field communication device comprises:
transmitting identification information by the third electronic terminal by using the near-field communication device, so that the first electronic terminal adds the third electronic terminal into the session according to the identification information.

6. The method according to claim 4, wherein before the third electronic terminal establishes the phone connection with the second electronic terminal, the method further comprises:
acknowledging whether to add into the session by the third electronic terminal.

7. A phone connection method, comprising:
receiving a phone request from a second electronic terminal by a first electronic terminal; and
establishing association by the first electronic terminal with a third electronic terminal by using a near-field communication device, so that the third electronic terminal establishes phone connection with the second electronic terminal.

8. The method according to claim 7, wherein the establishing association by the first electronic terminal with a third electronic terminal by using a near-field communication device comprises: receiving identification information of the third electronic terminal by the first electronic terminal by using the near-field communication device;
and the method further comprises:
forwarding the phone request of the second electronic terminal to the third electronic terminal according to the identification information, so that the third electronic terminal establishes the phone connection with the second electronic terminal.

9. A phone connection method, comprising:
establishing association by a third electronic terminal with a first electronic terminal by using a near-field communication device; and
establishing phone connection by the third electronic terminal with a second electronic terminal transmitting a phone request to the first electronic terminal.

10. The method according to claim 9, wherein the establishing association by a third electronic terminal with a first electronic terminal by using a near-field communication device comprises:
transmitting identification information by the third electronic terminal by using the near-field communication device, so that the first electronic terminal forwards the phone request of the second electronic terminal to the third electronic terminal according to the identification information.

11. The method according to claim 9, wherein before the third electronic terminal establishes the phone connection with the second electronic terminal, the method further comprises:
acknowledging by the third electronic terminal whether to establish phone connection with the second electronic terminal.

12. An electronic terminal, comprising a phone connection device, the phone connection device comprising:
a session establishing unit, configured to establish a session with a second electronic terminal; and
an association establishing unit, configured to establish association with a third electronic terminal by using a near-field communication device, so that the third electronic terminal establishes phone connection with the second electronic terminal.

13. The electronic terminal according to claim 12, wherein the association establishing unit receives identification information of the third electronic terminal by using the near-field communication device;
and the phone connection device further comprises:
a session adding unit, configured to add the third electronic terminal into the session according to the identification information, so that the third electronic terminal establishes phone connection with the second electronic terminal.

14. The electronic terminal according to claim 13, wherein the phone connection device further comprises:
a session exiting unit, configured to exit the session.

15. An electronic terminal, comprising a phone connection device, the phone connection device comprising:
an association establishing unit, configured to establish association with a first electronic terminal by using a near-field communication device; and
a phone connecting unit, configured to establish phone connection with a second electronic terminal that has established a session with the first electronic terminal.

16. The electronic terminal according to claim 15, wherein the association establishing unit transmits identification information by using the near-field communication device, so that the first electronic terminal adds the third electronic terminal into the session according to the identification information.

17. The electronic terminal according to claim 15, wherein the phone connection device further comprises:
an acknowledging unit, configured to acknowledge whether to add into the session.

18. An electronic terminal, comprising a phone connection device, the phone connection device comprising:
a request receiving unit, configured to receive a phone request from a second electronic terminal; and
an association establishing unit, configured to establish association with a third electronic terminal by using a near-field communication device, so that the third electronic terminal establishes phone connection with the second electronic terminal.

19. The electronic terminal according to claim 18, wherein the association establishing unit receives identification information of the third electronic terminal by using the near-field communication device;
and the phone connection device further comprises:
a request forwarding unit, configured to forward the phone request of the second electronic terminal to the third electronic terminal according to the identification information, so that the third electronic terminal establishes the phone connection with the second electronic terminal.

20. An electronic terminal, comprising a phone connection device, the phone connection device comprising:
an association establishing unit, configured to establish association with a first electronic terminal by using a near-field communication device; and
a phone connecting unit, configured to establish phone connection with a second electronic terminal transmitting a phone request to the first electronic terminal.

21. The electronic terminal according to claim 20, wherein the association establishing unit transmits identification information by using the near-field communication device, so that the first electronic terminal forwards the phone request of the second electronic terminal to the third electronic terminal according to the identification information.

22. The electronic terminal according to claim 20, wherein the phone connection device further comprises:
an acknowledging unit, configured to acknowledge whether to establish phone connection with the second electronic terminal.

23. A phone connection system, comprising:
a first electronic terminal, configured to establish a session with a second electronic terminal, and to establish association with a third electronic terminal by using a near-field communication device, so that the third electronic terminal establishes phone connection with the second electronic terminal;
a second electronic terminal, configured to establish a session with the first electronic, and to establish phone connection with the third terminal electronic terminal via the first electronic terminal; and
a third electronic terminal, configured to establish association with the first electronic terminal by using the near-field communication device, and to establish phone connection with the second electronic terminal via the first electronic terminal.

24. A phone connection system, comprising:
a first electronic terminal, configured to receive a phone request of a second electronic terminal, and to establish association with a third electronic terminal by using a near-field communication device, so that the third electronic terminal establishes phone connection with the second electronic terminal;
a second electronic terminal, configured to transmit a phone request to the first electronic terminal, and to establish phone connection with the third electronic terminal via the first electronic terminal; and
a third electronic terminal, configured to establish association with the first electronic terminal by using a near-field communication device, and to establish phone connection with the second electronic terminal via the first electronic terminal.
